(19) United States
(12) Patent Application Publication
(10) Pub. No.: US 2009/0278795 A1
(43) Pub. Date: Nov. 12, 2009

(54) Interactive Input System And Illumination Assembly Therefor

(75) Inventors: Jeremy Hansen, Calgary (CA); Alex Chtchetinine, Calgary (CA); Wolfgang Friedrich, Calgary (CA); Zoran Nesic, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary (CA)

(21) Appl. No.: 12/118,552

(22) Filed: May 9, 2008

(51) Int. Cl. G09G 5/00

(52) U.S. Cl. 345/156

(57) ABSTRACT

An illumination assembly for an interactive input system comprises at least two proximate radiation sources directing radiation into a region of interest, each of the radiation sources having a different emission angle.

### FIELD OF THE INVENTION

The present invention relates to an interactive input system and to an illumination assembly therefor.

### BACKGROUND OF THE INVENTION

Interactive input systems that allow users to input ink into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made, are used by a computer to control execution of an application program executed by the computer.

In order to determine the type of pointer used to contact the touch surface, in one embodiment a curve of growth method is employed to differentiate between different pointers. During this method, a horizontal intensity profile (HIP) is formed by calculating a sum along each row of pixels in each acquired image thereby to produce a one-dimensional profile having a number of points equal to the row dimension of the acquired image. A curve of growth is then generated from the HIP by forming the cumulative sum from the HIP.

Although passive touch systems provide some advantages over active touch systems and work extremely well, using both active and passive pointers in conjunction with a touch system provides more intuitive input modalities with a reduced number of processors and/or processor load.

Camera-based touch systems having multiple input modalities have been considered. For example, U.S. Pat. No. 7,202,860 to Ogawa discloses a camera-based coordinate input device allowing coordinate input using a pointer or finger. The coordinate input device comprises a pair of cameras positioned in the upper left and upper right corners of a display screen. The field of view of each camera extends to a diagonally opposite corner of the display screen in parallel with the display screen. Infrared emitting diodes are arranged close to the imaging lens of each camera and illuminate the surrounding area of the display screen. An outline frame is provided on three sides of the display screen. A narrow-width retro-reflection tape is arranged near the display screen on the outline frame. A non-reflective reflective black tape is attached to the outline frame along and in contact with the retro-reflection tape. The retro-reflection tape reflects the light from the infrared emitting diodes allowing the reflected light to be picked up as a strong white signal. When a user's finger is placed proximate to the display screen, the finger appears as a shadow over the image of the retro-reflection tape.

The video signals from the two cameras are fed to a control circuit, which detects the border between the white image of the retro-reflection tape and the outline frame. A horizontal line of pixels from the white image close to the border is selected. The horizontal line of pixels contains information related to a location where the user's finger is in contact with the display screen. The control circuit determines the coordinates of the touch position, and the coordinate value is then sent to a computer.

When a pen having a retro-reflective tip touches the display screen, the light reflected therefrom is strong enough to be registered as a white signal. The resulting image is not discriminated from the image of the retro-reflection tape. However, the resulting image is easily discriminated from the image of the black tape. In this case, a line of pixels from the black image close to the border of the outline frame is selected. Since the signal of the line of pixels contains information relating to the location where the pen is in contact with the display screen. The control circuit determines the coordinate value of the touch position of the pen and the coordinate value is then sent to the computer.

Although Ogawa is able to determine the difference between two passive pointers, the Ogawa system suffers disadvantages when detecting a finger that occludes illumination reflected by the retroreflective tape. The geometry of the Ogawa system does not allow the retroreflective tape to perform at its best and as a result, the white image of the retroreflective tape may vary in intensity over its length. It has been considered to place multiple light emitting diodes at spaced locations with each light emitting diode being responsible for illuminating a portion of the outline frame. In this case, the power outputs of the various light emitting diodes are adjusted depending on whether the light emitting diodes are responsible for illuminating a close portion of the outline frame or a far portion of the outline frame. As will be appreciated, improved lighting designs for interactive input systems are desired.

It is therefore an object of the present invention at least to provide a novel interactive input system and a novel illumination assembly therefor.

### SUMMARY OF THE INVENTION

Accordingly, in one aspect there is provided an illumination assembly comprising at least two proximate radiation sources directing radiation into a region of interest, each of said radiation sources having a different emission angle.

In one embodiment, the radiation sources are positioned adjacent an imaging assembly of the interactive input system that captures images of the region of interest. Each of the radiation sources is positioned proximate to the center line of the imaging assembly. The radiation sources are mounted on a board positioned on the imaging assembly. The board has an opening therein through which the imaging assembly looks. The radiation sources are mounted on the board on opposite sides of the opening. The radiation source having a narrow emission angle is positioned in the view of the imaging assembly. A shield inhibits stray light from the radiation source having the narrow emission angle from impinging on the imaging assembly.

In another embodiment, a lens is associated with at least one of the radiation sources. The lens shapes illumination emitted by the associated radiation source prior to the illumination entering the region of interest. The lens is shaped to provide a reflective component that redirects the off optical axis illumination rays and a refractive component that redirects near optical axis illumination rays.

According to another aspect there is provided an illumination assembly comprising at least one radiation source emitting illumination having a near-Lambertian directivity pattern and a lens associated with said radiation source, said lens shaping the illumination emitted by said radiation source to reduce diverging illumination rays along a selected axis.

According to yet another aspect there is provided an interactive input system comprising at least one imaging device capturing images of a region of interest surrounded at least partially by a reflective bezel and at least two radiation sources directing radiation into the region of interest, each of said radiation sources having a different emission angle.

### BRIEF DESCRIPTION OF THE DRAWINGS

Embodiments will now be described more fully with reference to the accompanying drawings in which:

FIG. 1 is a perspective view of an interactive input system;

FIG. 2 is a block diagram view of the interactive input system of FIG. 1;

FIG. 3 is a block diagram of an imaging assembly forming part of the interactive input system of FIG. 1;

FIG. 4 is a block diagram of a current control and IR light source comprising two light emitting diodes, forming part of the imaging assembly of FIG. 3;

FIG. 5 is a side elevational view of the IR light source;

FIG. 6 is a perspective view of the IR light source;

FIG. 7 is a schematic view showing the emission angles of illumination emitted by the IR light source;

FIG. 8 is a front elevational view of a portion of a bezel segment forming part of the interactive input system of FIG. 1;

FIG. 9 is a block diagram of a digital signal processor forming part of the interactive input system of FIG. 1;

FIGS. 10a to 10c are image frames captured by the imaging assembly of FIG. 3;

FIGS. 11a to 11c show plots of normalized VIP_{dark}, VIPᵣₑₜᵣₒ and D(x) values calculated for the pixel columns of the image frames of FIGS. 10a to 10c;

FIG. 12 is a side elevational view of a pen tool used in conjunction with the interactive input system of FIG. 1;

FIG. 13 is a side elevational view of a lens for use with a light emitting diode of an IR light source;

FIG. 14 is a front elevational view of the lens of FIG. 13;

FIG. 15 is a section of FIG. 13 taken along lines 15-15;

FIG. 16 is a section of FIG. 13 taken along lines 16-16;

FIG. 17 is an isometric view of the lens of FIG. 13;

FIG. 18 is a perspective view showing the path of light emitted by a light emitting diode fitted with the lens of FIG. 13.

### DETAILED DESCRIPTION OF THE EMBODIMENTS

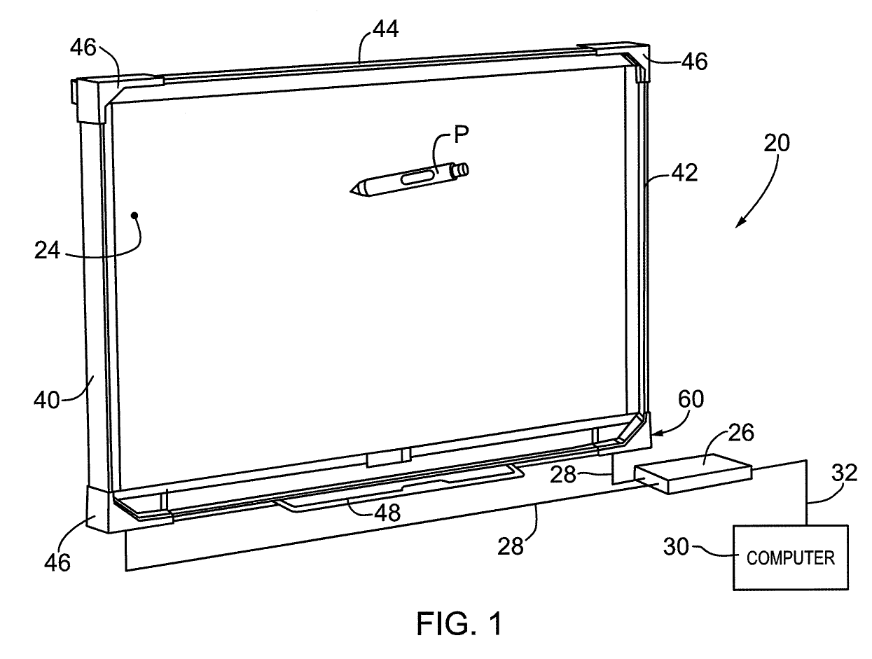

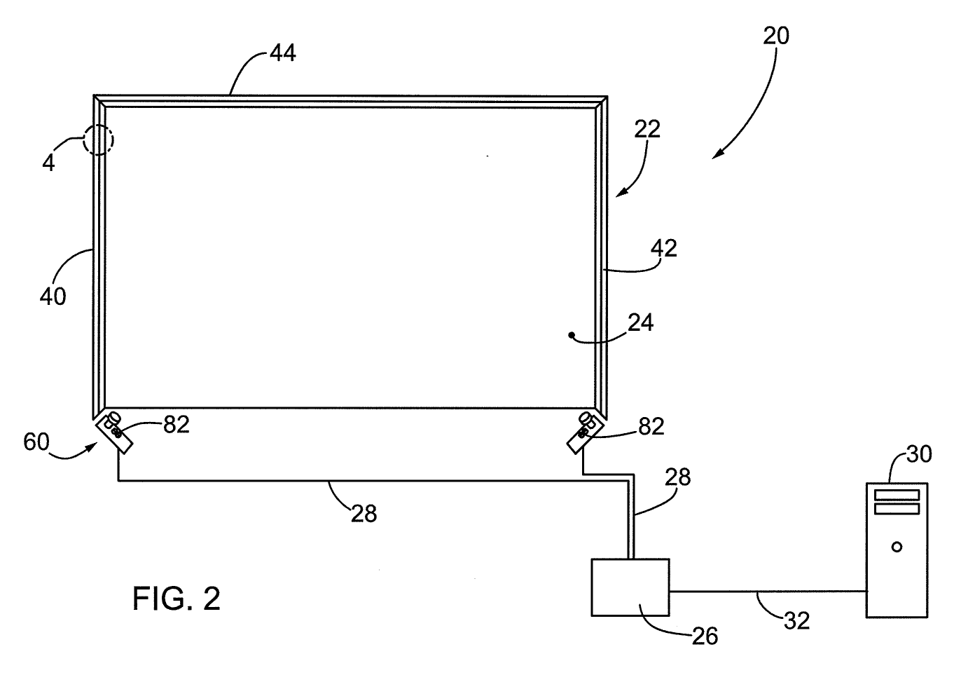

Turning now to FIGS. 1 and 2, an interactive input system that allows a user to input ink into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into a region of interest in proximity with the display surface 24 and communicates with a digital signal processor (DSP) unit 26 via communication lines 28. The communication lines 28 may be embodied in a serial bus, a parallel bus, a universal serial bus (USB), an Ethernet connection or other suitable wired connection. The DSP unit 26 in turn communicates with a computer 30 executing one or more application programs via a USB cable 32. Alternatively, the DSP unit 26 may communicate with the computer 30 over another wired connection such as for example, a parallel bus, an RS-232 connection, an Ethernet connection etc. or may communicate with the computer 30 over a wireless connection using a suitable wireless protocol such as for example Bluetooth, WiFi, ZigBee, ANT, IEEE 802.15.4, Z-Wave etc. Computer 30 processes the output of the assembly 22 received via the DSP unit 26 and adjusts image data that is output to the display unit so that the image presented on the display surface 24 reflects pointer activity. In this manner, the assembly 22, DSP unit 26 and computer 30 form a closed loop allowing pointer activity proximate to the display surface 24 to be recorded as writing or drawing or used to control execution of one or more application programs executed by the computer 30.

Assembly 22 comprises a frame assembly that is mechanically attached to the display unit and surrounds the display surface 24. Frame assembly comprises a bezel having three bezel segments 40 to 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more active pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60 that look generally across the entire display surface 24 from different vantages. The bezel segments 40 to 44 are oriented so that their inwardly facing surfaces are seen by the imaging assemblies 60.

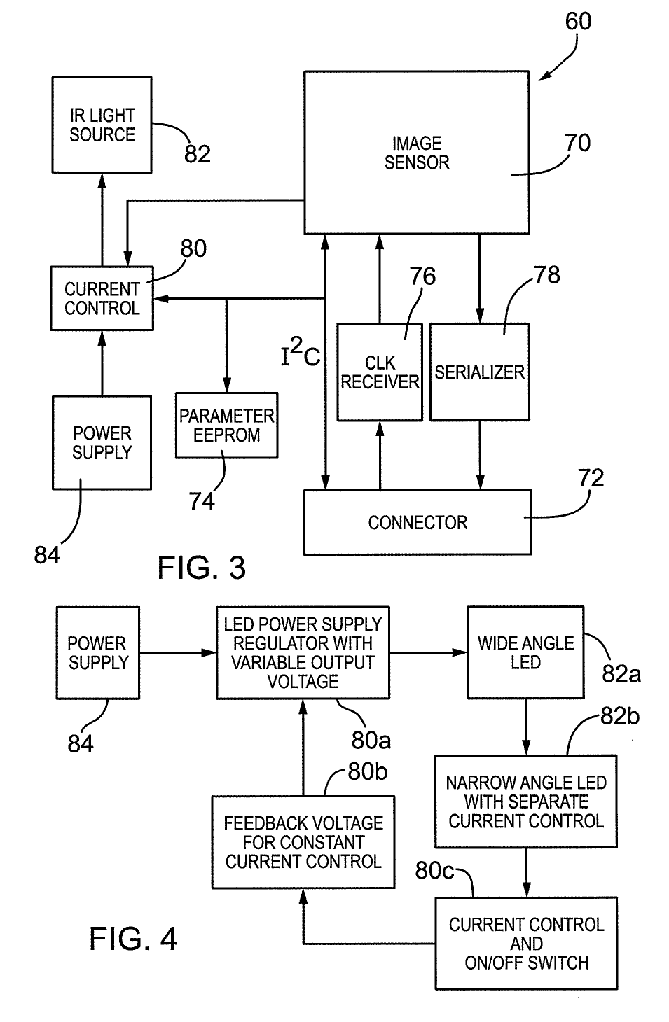

Turning now to FIG. 3, one of the imaging assemblies 60 is better illustrated. As can be seen, the imaging assembly 60 comprises an image sensor 70 such as that manufactured by Micron under model No. MT9V022 fitted with an 880 nm lens of the type manufactured by Boowon under model No. BW25B. The lens has an IR-pass/visible light blocking filter thereon (not shown) and provides the image sensor 70 with a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is also connected to an infrared (IR) light source 82 comprising a plurality of IR light emitting diodes (LEDs) and associated lens assemblies as well as to a power supply 84 and the connector 72. Of course, those of skill in the art will appreciate that other types of suitable radiation sources to provide illumination to the region of interest may be used.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determines the rate at which the image sensor 70 captures and outputs image frames. Each image frame output by the image sensor 70 is serialized by the serializer 78 and output to the DSP unit 26 via the connector 72 and communication lines 28.

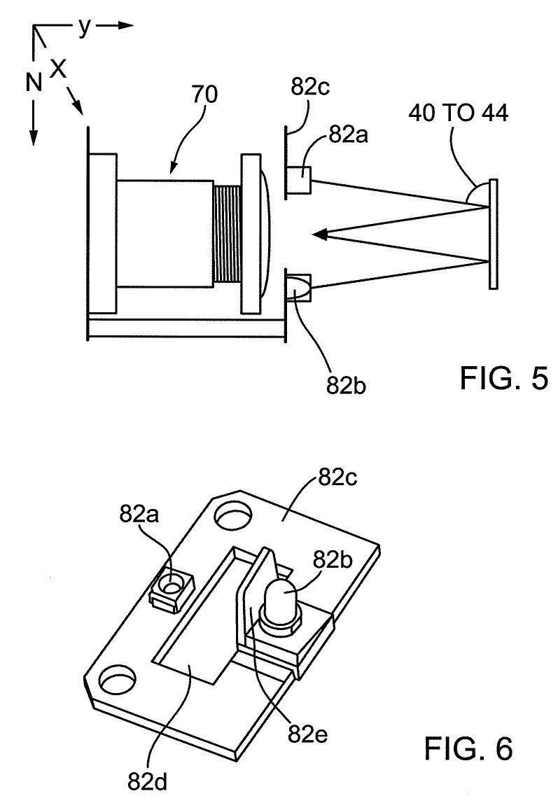

Turning now to FIGS. 4 to 6, the current control module 80 and IR light source 82 are better illustrated. As can be seen, the current control module 80 comprises a linear power supply regulator 80a connected to the power supply 84 and to the IR light source 82. The power supply regulator 80a receives a feedback voltage 80b from a current control and on/off switch 80c that is also connected to the IR light source 82.

The IR light source 82 in this embodiment comprises a pair of commercially available infrared light emitting diodes (LEDs) 82a and 82b respectively. The IR LEDs 82a and 82b are mounted on a board 82c positioned over the image sensor 70. The board 82c helps to shield the image sensor 70 from ambient light and light from external light sources and has a rectangular opening 82d therein through which the image sensor 70 looks giving the image sensor an unobstructed view of the region of interest and the bezel segments 40 to 44. Each IR LED is positioned on an opposite side of the image sensor 70 proximate the centerline of the image sensor. IR LED 82a is a wide beam LED and has a radiation emission angle equal to approximately 120°. IR LED 82b is a narrow beam LED and has a radiation emission angle equal to approximately 26°. The narrow beam IR LED 82b is mounted on a shield 82e that positions the narrow beam IR LED 82b in front of the image sensor 70. The shield 82e inhibits stray light from the narrow beam IR LED 82b from hitting the image sensor 70 directly.

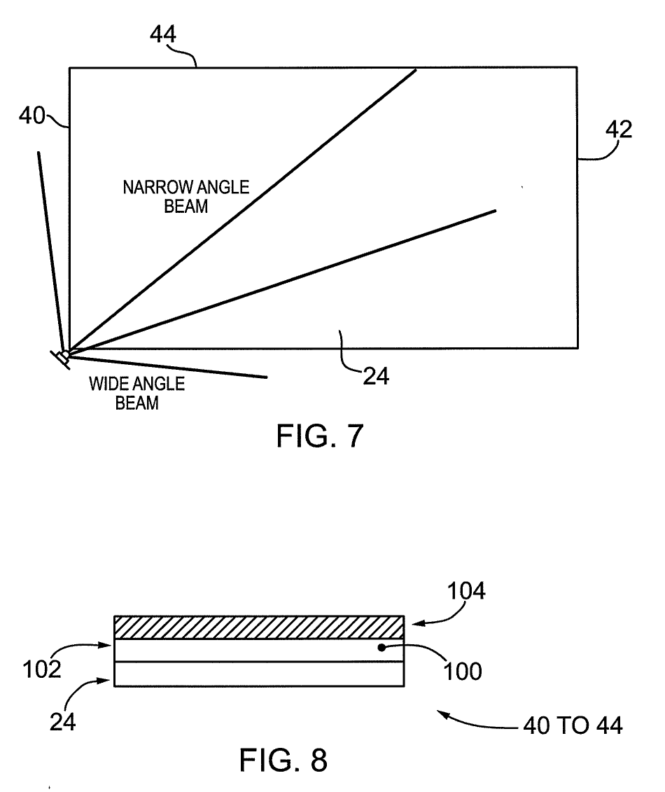

The wide beam IR LED 82 emits IR illumination generally over the entire region of interest. The narrow beam IR LED 82b is aimed so that IR illumination emitted thereby is directed towards the portions of the bezel segments that meet at the opposite diagonal corner of the display surface 24 as shown in FIG. 7. In this manner, the portions of the bezel segments 40 to 44 that are furthest from the IR light source 82 receive additional illumination so that the bezel segments are substantially evenly illuminated.

FIG. 8 shows a portion of the inwardly facing surface 100 of one of the bezel segments 40 to 44. As can be seen, the inwardly facing surface 100 is divided into a plurality of generally horizontal strips or bands, each band of which has a different optical property. In this embodiment, the inwardly facing surface 100 of the bezel segment is divided into two (2) bands 102 and 104. The band 102 nearest the display surface 24 is formed of a retro-reflective material and the band 104 furthest from the display surface 24 is formed of an infrared (IR) radiation absorbing material. To take best advantage of the properties of the retro-reflective material, the bezel segments 40 to 44 are oriented so that their inwardly facing surfaces extend in a plane generally normal to that of the display surface 24.

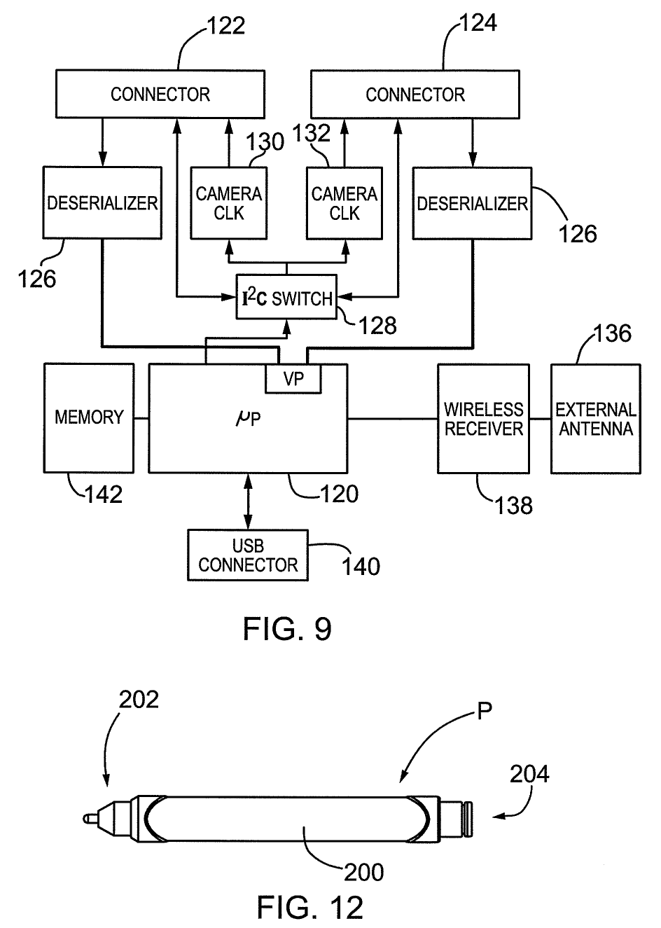

Turning now to FIG. 9, the DSP unit 26 is better illustrated. As can be seen, DSP unit 26 comprises a controller 120 such as for example, a microprocessor, microcontroller, DSP etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, each clock of which is connected to a respective one of the connectors 122, 124. The controller 120 communicates with an external antenna 136 via a wireless receiver 138, a USB connector 140 that receives USB cable 32 and memory 142 including volatile and non-volatile memory. The clocks 130 and 132 and deserializers 126 similarly employ low voltage, differential signaling (LVDS).

The interactive input system 20 is able to detect passive pointers such as for example, a user's finger, a cylinder or other suitable object as well as active pen tools P that are brought into proximity with the display surface 24 and within the fields of view of the imaging assemblies 60. For ease of discussion, the operation of the interactive input system 20, when a passive pointer is brought into proximity with the display surface 24, will firstly be described.

During operation, the controller 120 conditions the clocks 130 and 132 to output clock signals that are conveyed to the imaging assemblies 60 via the communication lines 28. The clock receiver 76 of each imaging assembly 60 uses the clock signals to set the frame rate of the associated image sensor 70. In this embodiment, the controller 120 generates clock signals so that the frame rate of each image sensor 70 is twice the desired image frame output rate. The controller 120 also signals the current control module 80 of each imaging assembly 60 over the I²C serial bus. In response, each current control module 80 connects the IR light source 82 to the power supply 84 and then disconnects the IR light source 82 from the power supply 84 so that each IR light source 82 turns on and off. The timing of the on/off IR light source switching is controlled so that for each pair of subsequent image frames captured by each image sensor 70, one image frame is captured when the IR light source 82 is on and one image frame is captured when the IR light source 82 is off.

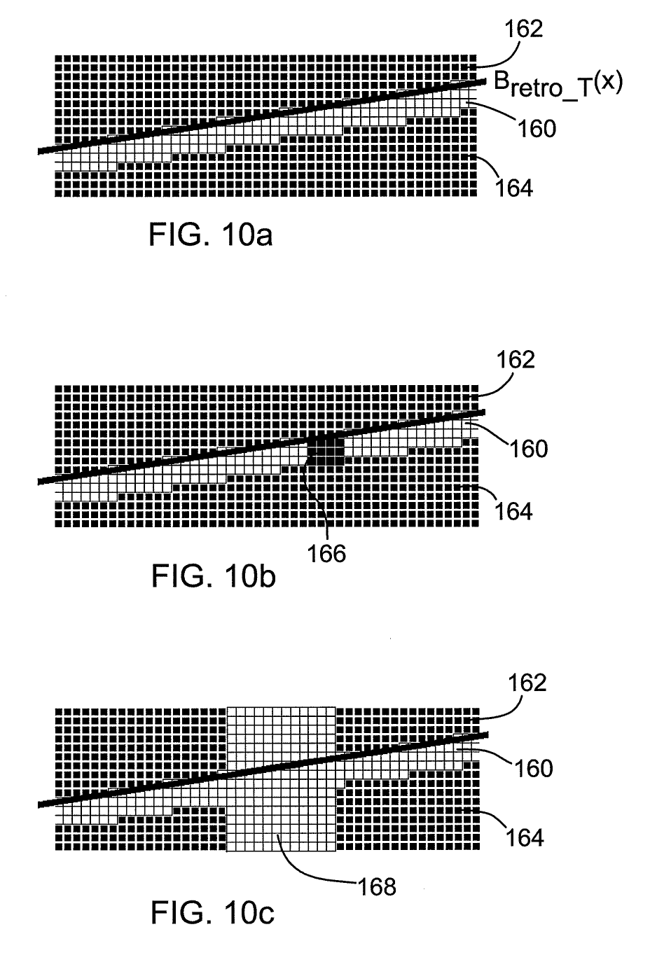

When the IR light sources 82 are on, the LEDs of the IR light sources flood the region of interest over the display surface 24 with infrared illumination. Infrared illumination that impinges on the IR radiation absorbing bands 104 of the bezel segments 40 to 44 is not returned to the imaging assemblies 60. Infrared illumination that impinges on the retro-reflective bands 102 of the bezel segments 40 to 44 is returned to the imaging assemblies 60. As mentioned above, the configuration of the IR LEDs of each IR light source 82 is selected so that the retro-reflective bands 102 are generally evenly illuminated over their entire lengths. As a result, in the absence of a pointer, the image sensor 70 of each imaging assembly 60 sees a bright band 160 having a substantially even intensity over its length disposed between an upper dark band 162 corresponding to the IR radiation absorbing bands 104 and a lower dark band 164 corresponding to the display surface 24 as shown in FIG. 10a. When a pointer is brought into proximity with the display surface 24 and is sufficiently distant from the IR light sources 82, the pointer occludes infrared illumination reflected by the retro-reflective bands 102. As a result, the pointer appears as a dark region 166 that interrupts the bright band 160 in captured image frames as shown in FIG. 10b.

As mentioned above, each image frame output by the image sensor 70 of each imaging assembly 60 is conveyed to the DSP unit 26. When the DSP unit 26 receives image frames from the imaging assemblies 60, the controller 120 processes the image frames to detect the existence of a pointer therein and if a pointer exists, to determine the position of the pointer relative to the display surface 24 using triangulation. To reduce the effects unwanted light may have on pointer discrimination, the controller 120 measures the discontinuity of light within the image frames rather than the intensity of light within the image frames to detect the existence of a pointer. There are generally three sources of unwanted light, namely ambient light, light from the display unit and infrared illumination that is emitted by the IR light sources 82 and scattered off of objects proximate to the imaging assemblies 60. As will be appreciated, if a pointer is close to an imaging assembly 60, infrared illumination emitted by the associated IR light source 82 may illuminate the pointer directly resulting in the pointer being as bright as or brighter than the retro-reflective bands 102 in captured image frames. As a result, the pointer will not appear in the image frames as a dark region interrupting the bright band 160 but rather will appear as a bright region 168 that extends across the bright band 160 and the upper and lower dark bands 162 and 164 as shown in FIG. 10c.

The controller 120 processes successive image frames output by the image sensor 70 of each imaging assembly 60 in pairs. In particular, when one image frame is received, the controller 120 stores the image frame in a buffer. When the successive image frame is received, the controller 120 similarly stores the image frame in a buffer. With the successive image frames available, the controller 120 subtracts the two image frames to form a difference image frame. Provided the frame rates of the image sensors 70 are high enough, ambient light levels in successive image frames will typically not change significantly and as a result, ambient light is substantially cancelled out and does not appear in the difference image frame.

Once the difference image frame has been generated, the controller 120 processes the difference image frame and generates discontinuity values that represent the likelihood that a pointer exists in the difference image frame. When no pointer is in proximity with the display surface 24, the discontinuity values are high. When a pointer is in proximity with the display surface 24, some of the discontinuity values fall below a threshold value allowing the existence of the pointer in the difference image frame to be readily determined.

In order to generate the discontinuity values for each difference image frame, the controller 120 calculates a vertical intensity profile (VIPᵣₑₜᵣₒ) for each pixel column of the difference image frame between bezel lines Bᵣₑₜᵣₒ_{_{—}}_{T}(x) and Bᵣₑₜᵣₒ_{_{—}}_{B}(x) that generally represent the top and bottom edges of the bright band 160 in the difference image and calculates a VIP_{dark} for each pixel column of the difference image frame between bezel lines B_{dark}_{_{—}}_{T}(x) and B_{dark}_{_{—}}_{B}(x) that generally represent the top and bottom edges of the upper dark band 162 in the difference image. The bezel lines are determined via a bezel finding procedure performed during calibration at interactive input system start up, as is described in U.S. patent application Ser. No. ______ to Hansen et al. entitled “Interactive Input System and Bezel Therefor” filed concurrently herewith and assigned to SMART Technologies ULC of Calgary, Alberta, the content of which is incorporated herein by reference.

The VIPᵣₑₜᵣₒ for each pixel column is calculated by summing the intensity values I of N pixels in that pixel column between the bezel lines Bᵣₑₜᵣₒ_{_{—}}_{T}(x) and Bᵣₑₜᵣₒ_{_{—}}_{B}(x). The value of N is determined to be the number of pixel rows between the bezel lines Bᵣₑₜᵣₒ_{_{—}}_{T}(x) and Bᵣₑₜᵣₒ_{_{—}}_{B}(x), which is equal to the width of the retro-reflective bands 102. If any of the bezel lines falls partway across a pixel of the difference image frame, then the intensity level contribution from that pixel is weighted proportionally to the amount of the pixel that falls inside the bezel lines Bᵣₑₜᵣₒ_{_{—}}_{T}(x) and Bᵣₑₜᵣₒ_{_{—}}_{B}(x). During VIPᵣₑₜᵣₒ calculation for each pixel column, the location of the bezel lines Bᵣₑₜᵣₒ_{_{—}}_{T}(x) and Bᵣₑₜᵣₒ_{_{—}}_{T}(x) within that pixel column are broken down into integer components Bᵢ_{_{—}}ᵣₑₜᵣₒ_{_{—}}_{T}(x), Bᵢ_{_{—}}ᵣₑₜᵣₒ_{_{—}}_{B}(x), and fractional components B_{f}_{_{—}}ᵣₑₜᵣₒ_{_{T}}(x) and Bᵢ_{_{—}}ᵣₑₜᵣₒ_{_{—}}_{B}(x) represented by:

Bᵢ_{_{—}}ᵣₑₜᵣₒ_{_{—}}_{T}(x)=ceil[Bᵣₑₜᵣₒ_{_{—}}_{T}(x)]

Bᵢ_{_{—}}ᵣₑₜᵣₒ_{_{—}}_{B}(x)=floor[Bᵣₑₜᵣₒ_{_{—}}_{B}(x)]

B_{f}_{_{—}}ᵣₑₜᵣₒ_{_{—}}_{T}(x)=Bᵢ_{_{—}}ᵣₑₜᵣₒ_{_{—}}_{T}(x)−Bᵣₑₜᵣₒ_{_{—}}_{T}(x)

B_{f}_{_{—}}ᵣₑₜᵣₒ_{_{—}}_{B}(x)=Bᵣₑₜᵣₒ_{_{—}}_{B}(x,y)−Bᵢ_{_{—}}ᵣₑₜᵣₒ_{_{—}}_{B}(x)

The VIPᵣₑₜᵣₒ for the pixel column is then calculated by summing the intensity values I of the N pixels along the pixel column that are between the bezel lines Bᵣₑₜᵣₒ_{_{—}}_{T}(x) and Bᵣₑₜᵣₒ_{_{—}}_{B}(x) with the appropriate weighting at the edges according to:

VIPᵣₑₜᵣₒ(x)=(B_{f}_{_{—}}ᵣₑₜᵣₒ_{_{—}}_{T}(x)I(x, Bᵢ_{_{—}}ᵣₑₜᵣₒ_{_{—}}_{T}(x)−1)+(B_{f}_{_{—}}ᵣₑₜᵣₒ_{_{—}}_{B}(x)I(x, Bᵢ_{_{—}}ᵣₑₜᵣₒ_{_{—}}_{B}(x))+sum(I(x, Bᵢ_{_{—}}ᵣₑₜᵣₒ_{_{—}}_{T}+j)

where N=(Bᵢ_{_{—}}ᵣₑₜᵣₒ_{_{—}}_{B}(x)−Bᵢ_{_{—}}ᵣₑₜᵣₒ_{_{—}}_{T}(x)), j is in the range of 0 to N and I is the intensity at location x between the bezel lines.

The VIP_{dark} for each pixel column is calculated by summing the intensity values I of K pixels in that pixel column between the bezel lines B_{dark}_{_{—}}_{T}(x) and B_{dark}_{_{—}}_{B}(x). The value of K is determined to be the number of pixel rows between the bezel lines B_{dark}_{_{—}}_{T}(x) and B_{dark}_{_{—}}_{B}(x), which is equal to the width of the IR radiation absorbing bands 104. If any of the bezel lines falls partway across a pixel of the difference image frame, then the intensity level contribution from that pixel is weighted proportionally to the amount of the pixel that falls inside the bezel lines B_{dark}_{_{—}}_{T}(x) and B_{dark}_{_{—}}_{B}(x). During VIP_{dark} calculation for each pixel column, the location of the bezel lines B_{dark}_{_{—}}_{T}(x) and B_{dark}_{_{—}}_{B}(x) within that pixel column are broken down into integer components Bᵢ_{_{—}}_{dark}_{_{—}}_{T}(x), Bᵢ_{_{—}}_{dark}_{_{—}}_{B}(x), and fractional components B_{f}_{_{—}}_{dark}_{_{—}}_{T}(x) and Bᵢ_{_{—}}_{dark}_{_{—}}_{B}(x) represented by:

Bᵢ_{_{—}}ᵣₑₜᵣₒ_{_{—}}_{T}(x)=ceil[Bᵣₑₜᵣₒ_{_{—}}_{T}(x)]

Bᵢ_{_{—}}ᵣₑₜᵣₒ_{_{—}}_{B}(x)=floor[Bᵣₑₜᵣₒ_{_{—}}_{B}(x)]

B_{f}_{_{—}}ᵣₑₜᵣₒ_{_{—}}_{T}(x)=Bᵢ_{_{—}}ᵣₑₜᵣₒ_{_{—}}_{T}(x)−Bᵣₑₜᵣₒ_{_{—}}_{T}(x)

B_{f}_{_{—}}ᵣₑₜᵣₒ_{_{—}}_{B}(x)=Bᵣₑₜᵣₒ_{_{—}}_{B}(x,y)−Bᵢ_{_{—}}ᵣₑₜᵣₒ_{_{—}}_{B}(x)

The VIP_{dark} for each pixel column is calculated in a similar manner by summing the intensity values I of the K pixels along the pixel column that are between the bezel lines B_{dark}_{_{—}}_{T}(x) and B_{dark}_{_{—}}_{B}(x) with the appropriate weighting at the edges according to:

VIP_{dark}(x)=(B_{f}_{_{—}}_{dark}_{_{—}}_{T}(x)I(x, Bᵢ_{_{—}}_{dark}_{_{—}}_{T}(x)−1)+(B_{f}_{_{—}}_{dark}_{_{—}}_{B}(x)I(x, Bᵢ_{_{—}}_{dark}_{_{—}}_{B}(x))+sum(I(x, Bᵢ_{_{—}}_{dark}_{_{—}}_{T}+j)

where K=(Bᵢ_{_{—}}_{dark}_{_{—}}_{B}(x)−Bᵢ_{_{—}}_{dark}_{_{—}}_{T}(x)) and j is in the range of 0 to N.

The VIPs are subsequently normalized by dividing them by the corresponding number of pixel rows (N for the retro-reflective regions, and K for the dark regions). The discontinuity value D(x) for each pixel column is then calculated by determining the difference between VIPᵣₑₜᵣₒ and VIP_{dark} according to:

D(x)=VIPᵣₑₜᵣₒ(x)−VIP_{dark}(x)

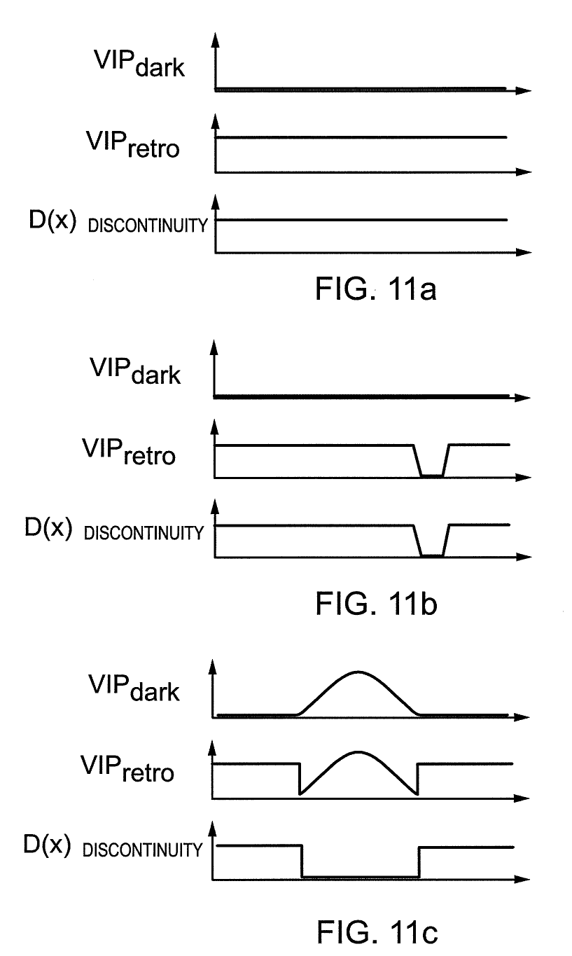

FIG. 11a shows plots of the normalized VIP_{dark}, VIPᵣₑₜᵣₒ and D(x) values calculated for the pixel columns of the image frame of FIG. 10a. As will be appreciated, in this image frame no pointer exists and thus, the discontinuity values D(x) remain high for all of the pixel columns of the image frame. FIG. 11b shows plots of the normalized VIP_{dark}, VIPᵣₑₜᵣₒ and D(x) values calculated for the pixel columns of the image frame of FIG. 10b. As can be seen, the D(x) curve drops to low values at a region corresponding to the location of the pointer in the image frame. FIG. 11c shows plots of the normalized VIP_{dark}, VIPᵣₑₜᵣₒ and D(x) values calculated for the pixel columns of the image frame of FIG. 10c. As can be seen, the D(x) curve also drops to low values at a region corresponding to the location of the pointer in the image frame.

Once the discontinuity values D(x) for the pixel columns of each difference image frame have been determined, the resultant D(x) curve for each difference image frame is examined to determine if the D(x) curve falls below a threshold value signifying the existence of a pointer and if so, to detect left and right edges in the D(x) curve that represent opposite sides of a pointer. In particular, in order to locate left and right edges in each difference image frame, the first derivative of the D(x) curve is computed to form a gradient curve ∇D(x). If the D(x) curve drops below the threshold value signifying the existence of a pointer, the resultant gradient curve ∇D(x) will include a region bounded by a negative peak and a positive peak representing the edges formed by the dip in the D(x) curve. In order to detect the peaks and hence the boundaries of the region, the gradient curve ∇D(x) is subjected to an edge detector.

In particular, a threshold T is first applied to the gradient curve ∇D(x) so that, for each position x, if the absolute value of the gradient curve ∇D(x) is less than the threshold, that value of the gradient curve ∇D(x) is set to zero as expressed by:

∇D(x)=0, if |∇D(x)|<T

Following the thresholding procedure, the thresholded gradient curve ∇D(x) contains a negative spike and a positive spike corresponding to the left edge and the right edge representing the opposite sides of the pointer, and is zero elsewhere. The left and right edges, respectively, are then detected from the two non-zero spikes of the thresholded gradient curve ∇D(x). To calculate the left edge, the centroid distance CD_{left} is calculated from the left spike of the thresholded gradient curve ∇D(x) starting from the pixel column X_{left} according to:

$$C {D}_{left} = \frac{{\sum }_{i} ( {x}_{i} - {X}_{left} ) ∇ D ( {x}_{i} )}{{\sum }_{i} ∇ D ( {x}_{i} )}$$

where xᵢ is the pixel column number of the i-th pixel column in the left spike of the gradient curve ∇D(x), i is iterated from 1 to the width of the left spike of the thresholded gradient curve ∇D(x) and X_{left} is the pixel column associated with a value along the gradient curve ∇D(x) whose value differs from zero (0) by a threshold value determined empirically based on system noise. The left edge in the thresholded gradient curve ∇D(x) is then determined to be equal to X_{left}+CD_{left}.

To calculate the right edge, the centroid distance CD_{right} is calculated from the right spike of the thresholded gradient curve ∇D(x) starting from the pixel column X_{right} according to:

$$C {D}_{right} = \frac{{\sum }_{j} ( {x}_{i} - {X}_{right} ) ∇ D ( {x}_{j} )}{{\sum }_{j} ∇ D ( {x}_{j} )}$$

where xⱼ is the pixel column number of the j-th pixel column in the right spike of the thresholded gradient curve ∇D(x), j is iterated from 1 to the width of the right spike of the thresholded gradient curve ∇D(x) and X_{right} is the pixel column associated with a value along the gradient curve ∇D(x) whose value differs from zero (0) by a threshold value determined empirically based on system noise. The right edge in the thresholded gradient curve is then determined to be equal to X_{right}+CD_{right}.

Once the left and right edges of the thresholded gradient curve ∇D(x) are calculated, the midpoint between the identified left and right edges is then calculated thereby to determine the location of the pointer in the difference image frame.

After the location of the pointer in each difference frame has been determined, the controller 120 uses the pointer positions in the difference image frames to calculate the position of the pointer in (x,y) coordinates relative to the display surface 24 using triangulation in a manner similar to that described in above incorporated U.S. Pat. No. 6,803,906 to Morrison et al. The calculated pointer coordinate is then conveyed by the controller 120 to the computer 30 via the USB cable 32. The computer 30 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computer 30.

The emission angles of the IR LEDs 82a and 82b set forth above are exemplary and those of skill in the art will appreciate that the emission angles may be varied. In addition, one or more of the IR light sources 82 may be provided with more than two IR LEDs. Depending on the size and geometry of the display surface 24 and hence bezel, the number and configuration of the IR LEDs may vary to suit the particular environment.

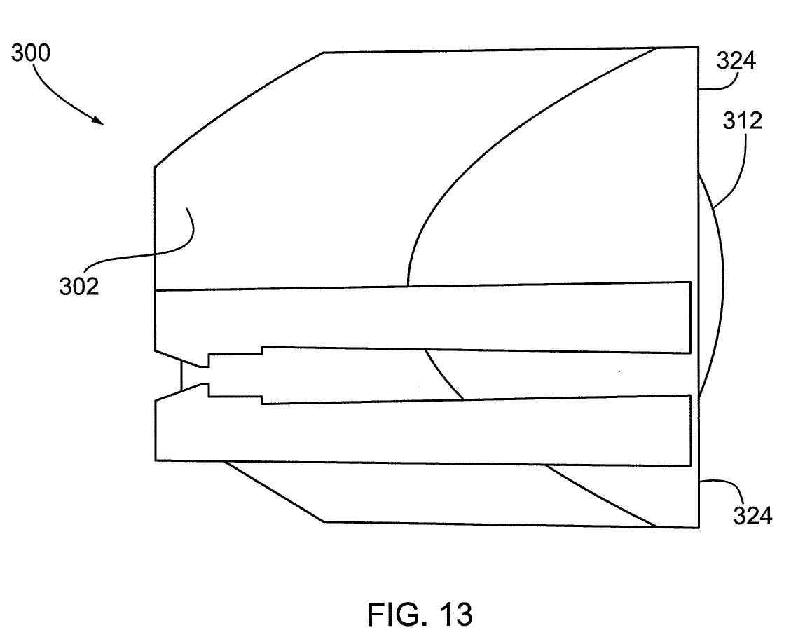

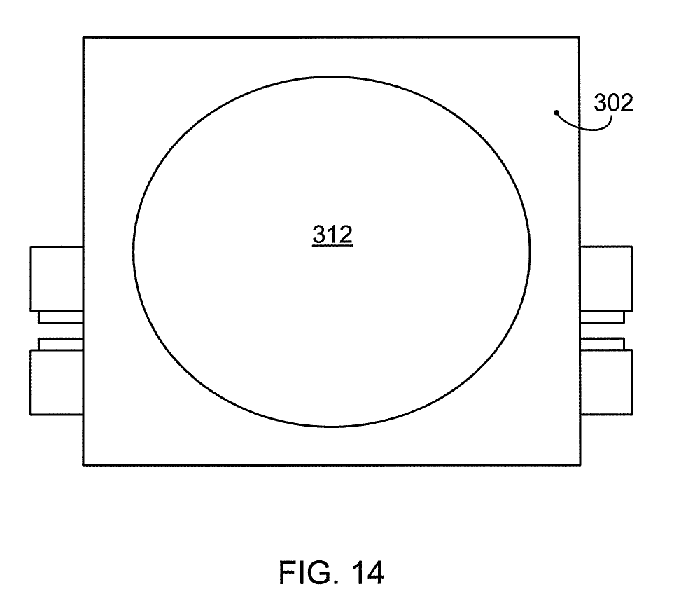

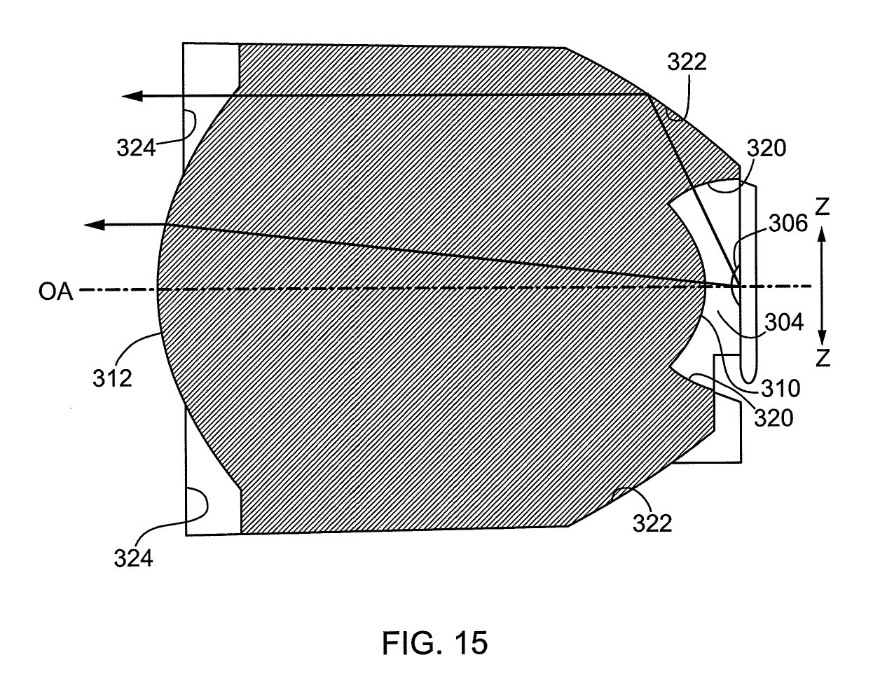

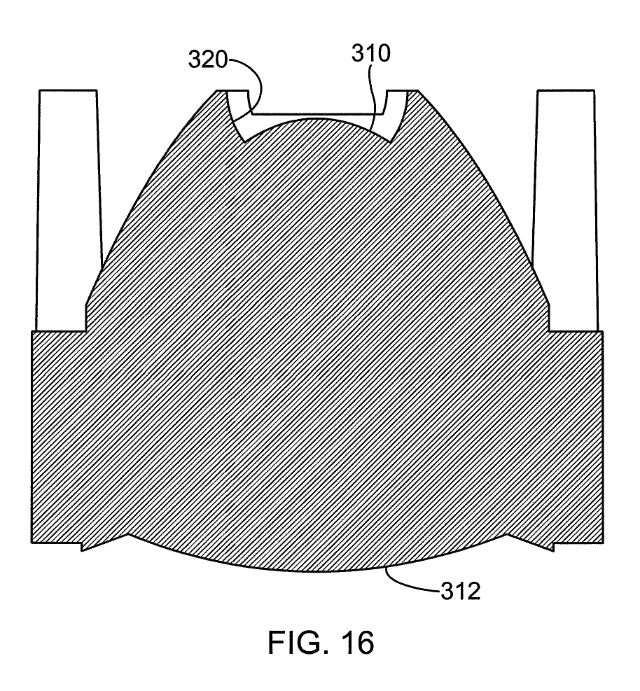

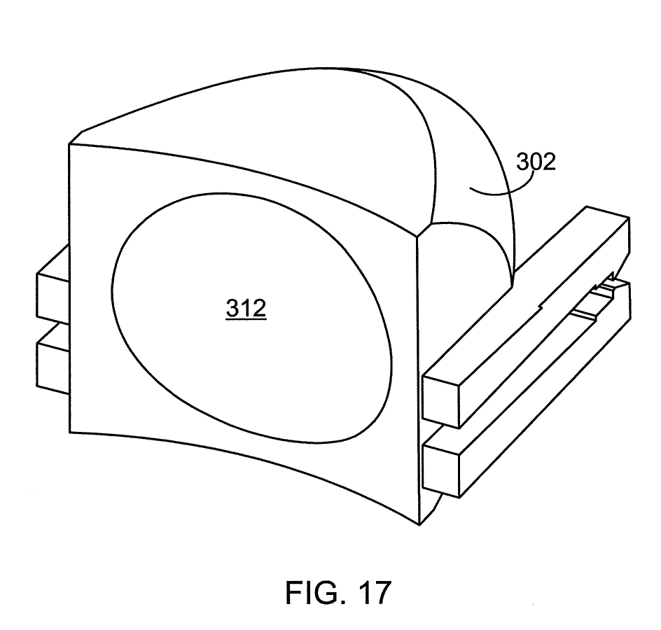

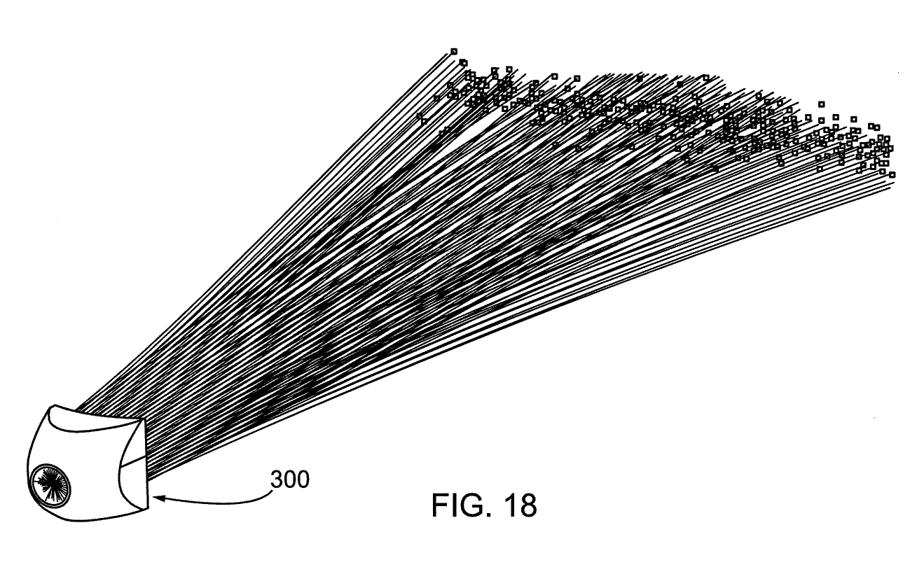

For example, if desired, rather than including IR LEDs with different emission angles, the IR light sources 82 may comprise a series of spaced, surface mount IR LEDs proximate to the imaging assemblies 60, with each IR LED having the same emission angle and being responsible for illuminating an associated section of the bezel. For IR LEDs associated with far bezel portions, the power output of these LEDs can be increased as compared to the power output of IR LEDs associated with near portions of the bezel to ensure the bezel is generally evenly illuminated. As is known, commercially available surface mount IR LEDs have near-Lambertian directivity patterns meaning that they radiate light in all directions in a hemisphere. As a result, illumination emitted by such IR LEDs will pass over the bezel. To reduce the amount of wasted illumination, if surface mount IR LEDSs are employed, one or more of the IR LEDs can be fitted with a tuned lens 300 as shown in FIGS. 13 to 18. The tuned lens 300 is designed to shape the output of the IR LED so that the z-component of the illumination is reduced resulting in more illumination hitting the bezel (i.e. the light radiates in a fan-shaped pattern). This is achieved by taking advantage of refraction for near optical axis illumination rays and total internal reflection (TIR) for off optical axis illumination rays.

The tuned lens 300 in this embodiment is formed of molded, substantially optically transparent plastic such as for example PC, PMMA, Zeonor etc. The body 302 of the lens 300 has a generally semi-spherical cavity 304 that receives the IR LED 306. The IR LED 306 is positioned so that it is centered in-line with the optical axis OA of the lens 300. The lens body 302 is configured to provide a TIR component and a refractive component and has five (5) optically active surfaces. The refractive component of the lens body 302 comprises generally parabolic surfaces 310 and 312 having the same optical axis. Parabolic surface 310 transects the cavity 304. Parabolic surface 312 is provided on the distal end of the lens body 302. Near optical axis illumination rays emitted by the IR LED 306 pass through parabolic surface 310 of the lens body 302 and are refracted by the parabolic surface 312 so that the near optical axis illumination rays exit the lens 300 traveling generally parallel to the optical axis OA in the z-direction.

The TIR component of the lens body 302 comprises three surfaces 320, 322 and 324. Off optical axis illumination rays emitted by the IR LED 306 pass through surface 320 of the lens body 302 and are redirected through total internal reflection by surface 322 of the lens body so that the illumination rays exit distal surface 324 of the lens 300 traveling generally parallel to the optical axis OA in the z-direction. The surface 322 is generally rotationally parabolic. The surface 324 as well as the surfaces 310 and 312 generally have no rotational symmetry and are represented in the design by two-dimensional polynomials of even powers.

As will be appreciated, the illumination output by the lens 300 is collimated in the vertical z-direction and divergent horizontally along the optical axis OA. The lens design has freedom to completely collimate or to control the degree of collimation or divergence in both directions to achieve the desired beam shape. As a result, the lens 300 focuses illumination so that the amount of emitted illumination that passes over the bezel or is directed into the display surface 24 is reduced thereby increasing the illumination that impinges on the bezel.

Those of skill in the art will appreciate that the configuration of the lens 300 may change depending on the size of the display surface 24 and hence bezel. If desired, the lens 300 may be used with IR LEDs of differing emission angles to reduce the amount of light emitted by these IR LEDs that passes over the bezel or is directed into the display surface 24. Although infrared illumination sources are described, those of skill in the art will appreciate that other illumination sources may be used. For example, the illumination source may be an incandescent light bulb or other suitable source. Irrespective of the illumination source used, emitted illumination may be directed to the lens indirectly using a mirrored surface or optical collection device.

Rather than using a pointer to interact with the display surface, a pen tool P having a body 200, a tip assembly 202 at one end of the body 200 and a tip assembly 204 at the other end of the body 200 as shown in FIG. 12 can be used in conjunction with the interactive input system 20. When the pen tool P is brought into proximity with the display surface 24, its location relative to the display surface in (x,y) coordinates is calculated in the same manner as described above with reference to the passive pointer. However, depending on the manner in which the pen tool P is brought into contact with the display surface 24, the pen tool P may provide mode information that is used to interpret pen tool activity relative to the display surface 24. Further specifics concerning the pen tool are described in above-incorporated Hansen et al. reference.

In the above embodiment, the DSP unit 26 is shown as comprising an antenna 136 and a wireless receiver 138 to receive the modulated signals output by the pen tool P. Alternatively, each imaging assembly 60 can be provided with an antenna and a wireless receiver to receive the modulated signals output by the pen tool P. In this case, modulated signals received by the imaging assemblies are sent to the DSP unit 26 together with the image frames. The pen tool P may also be tethered to the assembly 22 or DSP unit 26 allowing the signals output by the pen tool P to be conveyed to one or more of the imaging assemblies 60 or the DSP unit 26 or imaging assembly(s) over a wired connection.

In the above embodiments, each bezel segment 40 to 44 is shown as comprising a pair of bands having different reflective properties, namely retro-reflective and IR radiation absorbing. Those of skill in the art will appreciate that the order of the bands may be reversed. Also, bands having different reflective properties may be employed. For example, rather then using a retro-reflective band, a band formed of highly reflective material may be used. Alternatively, bezel segments comprising more than two bands with the bands having differing or alternating reflective properties may be used. For example, each bezel segment may comprise two or more retro-reflective bands and two or more radiation absorbing bands in an alternating arrangement. Alternatively, one or more of the retro-reflective bands may be replaced with a highly reflective band.

If desired the tilt of each bezel segment can be adjusted to control the amount of light reflected by the display surface itself and subsequently toward the image sensors 70 of the imaging assemblies 60.

Although the frame assembly is described as being attached to the display unit, those of skill in the art will appreciate that the frame assembly may take other configurations. For example, the frame assembly may be integral with the bezel 38. If desired, the assembly 22 may comprise its own panel to overlie the display surface 24. In this case it is preferred that the panel be formed of substantially transparent material so that the image presented on the display surface 24 is clearly visible through the panel. The assembly can of course be used with a front or rear projection device and surround a substrate on which the computer-generated image is projected.

Although the imaging assemblies are described as being accommodated by the corner pieces adjacent the bottom corners of the display surface, those of skill in the art will appreciate that the imaging assemblies may be placed at different locations relative to the display surface. Also, the tool tray segment is not required and may be replaced with a bezel segment.

Those of skill in the art will appreciate that although the operation of the interactive input system 20 has been described with reference to a single pointer or pen tool P being positioned in proximity with the display surface 24, the interactive input system 20 is capable of detecting the existence of multiple pointers/pen tools that are proximate to the touch surface as each pointer appears in the image frames captured by the image sensors.

Although preferred embodiments have been described, those of skill in the art will appreciate that variations and modifications may be made with departing from the spirit and scope thereof as defined by the appended claims.

What is claimed is:

1. An illumination assembly for an interactive input system comprising:
at least two proximate radiation sources directing radiation into a region of interest, each of said radiation sources having a different emission angle.

2. An illumination assembly according to claim 1 wherein said radiation sources are positioned adjacent an imaging assembly of said interactive input system that captures images of said region of interest.

3. An illumination assembly according to claim 2 wherein each of said radiation sources is positioned proximate to the centerline of said imaging assembly.

4. An illumination assembly according to claim 3 wherein said radiation sources are mounted on a board positioned on said imaging assembly, said board having an opening therein through which said imaging assembly looks.

5. An illumination assembly according to claim 4 wherein said radiation sources are mounted on said board on opposite sides of said opening.

6. An illumination assembly according to claim 5 wherein the radiation source having a narrow emission angle is positioned in the view of said imaging assembly.

7. An illumination assembly according to claim 6 further comprising a shield to inhibit stray light from the radiation source having the narrow emission angle from impinging on said imaging assembly.

8. An illumination assembly according to claim 2 wherein the region of interest has a bezel running along a plurality of sides thereof, the emission angles of the radiation sources being selected so that said bezel appears generally evenly illuminated in captured images.

9. An illumination assembly according to claim 8 wherein each of said radiation sources is positioned proximate to the centerline of said imaging assembly.

10. An illumination assembly according to claim 9 wherein said radiation sources are mounted on a board positioned on said imaging assembly, said board having an opening therein through which said imaging assembly looks.

11. An illumination assembly according to claim 10 wherein said radiation sources are mounted on said board on opposite sides of said opening.

12. An illumination assembly according to claim 11 wherein the radiation source having a narrow emission angle is positioned in the view of said imaging assembly.

13. An illumination assembly according to claim 12 further comprising a shield to inhibit stray light from the radiation source having the narrow emission angle from impinging on said imaging assembly.

14. An illumination assembly according to claim 8 wherein said region of interest is generally rectangular and wherein the imaging assembly is positioned adjacent a corner of said region of interest, the radiation source having a narrow emission angle being aimed generally towards the opposite diagonal corner of said region of interest.

15. An illumination assembly according to claim 14 wherein the radiation source having a narrow emission angle is positioned in the view of said imaging assembly.

16. An illumination assembly according to claim 15 further comprising a shield to inhibit stray light from the radiation source having the narrow emission angle from impinging on said imaging assembly.

17. An illumination assembly according to claim 1 further comprising a lens associated with at least one of said radiation sources, said lens shaping illumination emitted by said associated radiation source prior to said illumination entering said region of interest.

18. An illumination assembly according to claim 17 wherein said lens is shaped to provide a reflective component that redirects off optical axis illumination rays and a refractive component that redirects near optical axis illumination rays.

19. An illumination assembly according to claim 18 wherein said reflective component is a total internal reflection component.

20. An illumination assembly according to claim 17 wherein a lens is associated with each radiation source.

21. An illumination assembly according to claim 20 wherein said lens is shaped to provide a reflective component that redirects off optical axis illumination rays and a refractive component that redirects near optical axis illumination rays.

22. An illumination assembly according to claim 21 wherein said reflective component is a total internal reflection component.

23. An illumination assembly according to claim 18 wherein said refractive component comprises a pair of generally parabolic surfaces spaced along the optical axis of said lens.

24. An illumination assembly according to claim 21 wherein said refractive component comprises a pair of generally parabolic surfaces spaced along the optical axis of said lens.

25. An illumination assembly comprising:
at least one radiation source emitting illumination having a near-Lambertian directivity pattern; and
a lens associated with said radiation source, said lens shaping the illumination emitted by said radiation source to reduce diverging illumination rays along a selected axis.

26. An illumination assembly according to claim 25 wherein said lens is shaped to provide a reflective component that redirects off optical axis illumination rays and a refractive component that redirects near optical axis illumination rays.

27. An illumination assembly according to claim 26 wherein said refractive component comprises a pair of generally parabolic surfaces spaced along the optical axis of said lens.

28. An illumination assembly according to claim 27 wherein said reflective component is a total internal reflection component.

29. An illumination assembly according to claim 25 comprising:
a plurality of spaced radiation sources and a lens associated with each radiation source.

30. An illumination assembly according to claim 29 wherein said lens is shaped to provide a reflective component that redirects off optical axis illumination rays and a refractive component that redirects near optical axis illumination rays.

31. An illumination assembly according to claim 30 wherein said refractive component comprises a pair of generally parabolic surfaces spaced along the optical axis of said lens.

32. An illumination assembly according to claim 31 wherein said reflective component is a total internal reflection component.

33. An interactive input system comprising:
at least one imaging device capturing images of a region of interest surrounded at least partially by a reflective bezel; and
at least two radiation sources directing radiation into the region of interest, each of said radiation sources having a different emission angle.
